(19) United States
(12) Patent Application Publication
(10) Pub. No.: US 2003/0220921 A1
(43) Pub. Date: Nov. 27, 2003

(54) Optimal approximate approach to aggregating information

(75) Inventors: Ronald Fagin, Los Gatos, CA (US); Simeon Naor, Tel-Aviv (IL)

Correspondence Address: MARK D. MCSWAIN, IBM ALMADEN RESEARCH CENTER, IP LAW DEPT., 650 HARRY ROAD, CHTA/J2B, SAN JOSE, CA, 95120, US

(73) Assignee: IBM CORPORATION, ARMONK, NY

(21) Appl. No.: 10/153,448

(22) Filed: May 21, 2002

(51) Int. Cl. G06F 17/30

(52) U.S. Cl. 707/7

(57) ABSTRACT

A system, method, and computer program product for automatically determining in a computationally efficient manner which objects in a collection best match specified target attribute criteria. The preferred embodiment of the invention enables interruption of such an automated determination at any time and provides a measure of how closely the results achieved up to the interruption point match the criteria. An alternate embodiment combines sequential and random data access to minimize the overall computational cost of the determination.

### FIELD OF THE INVENTION

This invention relates to automatically determining in a computationally efficient manner which objects in a collection best match specified target attribute criteria. Specifically, the invention enables interruption of such an automated determination at any time and provides a measure of how closely the results achieved by the point of interruption match the criteria. An alternate embodiment combines sequential and random data access to minimize the overall computational cost of the determination.

### DESCRIPTION OF RELATED ART

The following articles are hereby incorporated by reference:

R. Fagin, A. Lotem, M. Naor. Optimal Aggregation Algorithms for Middleware (extended abstract). Proceedings of the Twentieth ACM SIGMOD-SIGACT-SIGART Symposium on Principles of Database Systems (PODS '01), Santa Barbara, Calif., p. 102-113, available online at doi.acm.org/10.1145/375551.375567

R. Fagin, A. Lotem, M. Naor. Optimal Aggregation Algorithms for Middleware (full paper), available online at www.almaden.ibm.com/cs/people/fagin/pods01rj.pdf

Unclaimed portions of the invention described in the above-identified articles were discussed verbally at a seminar at the EECS Department, University of California, Berkeley, on Apr. 19, 2001.

R. Fagin. Combining Fuzzy Information from Multiple Systems. Proceedings of the Fifteenth ACM SIGMOD-SIGACT-SIGART Symposium on Principles of Database Systems (PODS '96), pp. 216-226.

Early database systems were required to store only small character strings, such as the entries in a tuple in a traditional relational database. Thus, the data was quite homogeneous. Today, database systems need to handle not only character strings (large and small), but also a heterogeneous variety of multimedia data such as static images, video, and audio. Furthermore, the data to be accessed and combined may reside in a variety of repositories, so the database system must serve as middleware. These repositories are often attached to the internet, and search engines help with information retrieval tasks. Search engines typically generate a list of documents (or, more often, a list of locations on the internet where documents may be directly accessed) that are somehow deemed to be the most relevant to the user's query. These documents are usually those that include search terms specified by a user, but the precise scheme that a particular search engine uses to determine document relevance is often hidden from view.

One fundamental difference between small character strings and multimedia data is that multimedia data may have attributes that are inherently fuzzy. For example, one does not say that a given image is simply either “red” or “not red”. Instead, there is a degree of redness, which for example ranges between 0 (not at all red) and 1 (totally red). Similarly, a search engine's answer to a query can be thought of as a sorted list, with the answers having been sorted by a decreasing relevance score or grade. This answer is quite different from that of a traditional database, where the response to a query is generally a set of ungraded objects that each meet a set of crisply designed membership constraints, perhaps arranged somehow for convenient presentation.

Objects in a database each have a number of attributes, and each attribute of an object may be assigned a grade describing the degree to which that object meets an attribute description, e.g. how “red” is an object in a range spanning from 0 (not red at all) to 1 (totally red). A database of N objects each having m attributes can therefore be thought of as a set of m sorted lists, L₁, . . . ,Lₘ, each of length N, and each sorted by attribute grade (e.g. highest grade first, with ties broken arbitrarily). L₁ could be a list of the reddest objects, L₂ a list of the greenest objects, and Lₘ a list of the roundest objects for example. A user might want a list of the greenest roundest objects, which would presumably be generated somehow from L₂ and Lₘ, but how?

One approach to dealing with such fuzzy data is to use an aggregation function or combining rule, that combines individual grades to obtain an overall grade. Users are often interested in finding the set of k objects in a database that have the highest overall grade according to a particular query, such as “green AND round”, and in seeing the overall grades themselves. In this description, k is a constant, such as k=1 or k=10 or k=100, and algorithms are considered for obtaining the top k answers in databases containing at least k objects.

There are many different aggregation functions used for various purposes, as noted in the “Combining Fuzzy Information” paper by Fagin cited above. One popular choice for the aggregation function is min. Another is the average, or sum in cases where one does not necessarily care if the resulting overall grade no longer lies in the interval [0,1]. In information retrieval, for example, the objects are documents and the attributes are search terms, and the overall relevance grade of a particular document may be just the sum of the relevance grades computed separately for each of the search terms. In “RxW: A scheduling approach for large-scale on-demand data broadcast”, IEEE/ACM Transactions on Networking, 7(6):846-880, December 1999, hereby incorporated by reference, authors Aksoy and Franklin describe the use of the product aggregation function. In scheduling broadcasts, the objects are pages, and the relevant attributes are the amount of time waited by the earliest user requesting a page and the number of users requesting a page. The next page to be broadcast is selected according to the overall grade which is the product of these two attributes.

Monotonicity is a reasonable property to demand of an aggregation function: if for every attribute, the grade of object R′ is at least as high as that of object R, then one would expect the overall grade of R′ to be at least as high as that of R. An aggregation function t is monotone if, for individual attribute grades xᵢ, . . . ,xₘ, t(x₁, . . . ,xₘ)≦t(x′₁, . . . ,x′ₘ) whenever xᵢ≦x′ᵢ for every i.

There is an obvious naive algorithm for obtaining the top k answers: simply look at every entry in each of the m sorted lists, compute (using t) the overall grade of every object, and return the top k answers. Unfortunately, the naive algorithm has a linear middleware cost (linear in the database size), and thus is not computationally efficient for a large database.

Fagin introduced an algorithm (in the above-cited “Combining Fuzzy Information” paper) referred to as “Fagin's algorithm” or “FA”, which often performs much better than the naive algorithm. In the case where the orderings in the sorted lists are probabilistically independent, FA finds the top k answers, over a database with N objects, with middleware cost O(N^{(m-1)/m} k^{1/m}), with arbitrarily high probability. Fagin also proved that under this independence assumption, along with an assumption on the aggregation function, every correct algorithm must, with high probability, incur a similar middleware cost in the worst case. Fagin's algorithm works as follows:

1. Do sorted access in parallel to each of the m sorted lists Lᵢ. Wait until there are at least k “matches”, i.e. there is a set H of at least k objects such that each of these objects has been seen in each of the m lists.

2. For each object R that has been seen, do random access to each of the lists Lᵢ to find the i^{th} field xᵢ of R.

3. Compute the grade t(R)=t(x₁, . . . ,xₘ) for each object R that has been seen. Let Y be a set containing the k objects that have been seen with the highest grades (ties are broken arbitrarily). The output is then the graded set {(R,t(R))|RεY}.

Fagin's algorithm is correct (that is, successfully finds the top k answers) for monotone aggregation functions t.

Middleware cost is determined by the computational penalties imposed by two modes of accessing data. The first mode of access is sorted (or sequential) access, where the middleware system obtains the grade of an object in one of the sorted lists by proceeding through the list sequentially from the top. Thus, if object R has the w^{th} highest grade in the i^{th} list, then w sorted accesses to the i^{th} list are required to see this grade under sorted access. The second mode of access is random access, where the middleware system requests the grade of object R in the i^{th} list, and obtains it in one step. If there are s sorted accesses and r random accesses, then the sorted access cost is sc_{S}, the random access cost is rc_{R}, and the middleware cost is sc_{S}+rc_{R} (the sum of the sorted access cost and the random access cost), where c_{S} and c_{R} are positive but possibly different constants. In some cases, random access may be expensive relative to sorted access, or entirely impossible. Access costs usually depend on how the middleware system receives answers to queries from various subsystems, which can be accessed only in limited ways. For example, if the middleware system is a text retrieval system, and the subsystems are major web search engines, there is no apparent way to ask the search engines for internal scores on a document under a query.

Another algorithm, termed the “threshold algorithm” or “TA” is known in the art. This algorithm was discovered independently by several groups and was first published by S. Nepal and M. V. Ramakrishna in “Query Processing Issues in Image (Multimedia) Databases”, in Proc. 15^{th} International Conference on Data Engineering (ICDE), March 1999, pp. 22-29, hereby incorporated by reference. The threshold algorithm works as follows:

1. Do sorted access in parallel to each of the m sorted lists Lᵢ. As an object R is seen under sorted access in some list, do random access to the other lists to find the grade xᵢ of object R in every list Lᵢ. Then compute the grade t(R)=t(x₁, . . . ,xₘ) of object R. If this grade is one of the k highest seen, then remember object R and its grade t(R) (ties are broken arbitrarily, so that only k objects and their grades need to be remembered at any time).

2. For each list Lᵢ, let xᵢ be the grade of the last object seen under sorted access. Define the threshold value τ to be t(x₁, . . . ,xₘ). As soon as at least k objects have been seen whose grade is at least equal to τ, then halt.

3. Let Y be a set containing the k objects that have been seen with the highest grades. The output is then the graded set {(R,t(R))|RεY}.

The threshold algorithm is correct for each monotone aggregation function t. Unlike Fagin's algorithm, which requires large buffers (whose size may grow unboundedly as the database size grows), the threshold algorithm requires only a small, constant-size buffer. The threshold algorithm must track only the current top k objects and their grades, and the last objects seen in sorted order in each list. In contrast, Fagin's algorithm must track every object it has seen in sorted order in every list, in order to check for matching objects in the various lists. However, there is a price to pay for the bounded buffers; for every time an object is found under sorted access, the threshold algorithm may do m−1 random accesses to find the grade of the object in the other lists. This is in spite of the fact that this object may have already been seen under sorted or random access in one of the other lists.

Intuitively, the threshold algorithm can be summarized as “Gather what information is needed to allow the top k answers to be known, then halt”, or “Do sorted access (and the corresponding random access) until the top k answers have been seen”. Consider the case where k=1, where the user is trying to determine the top answer. If the algorithm has not yet seen any object whose overall grade is at least as big as the threshold value τ, the top answer is not known; the next object seen under sorted access could have an overall grade τ, and hence bigger than the grade of any object seen so far. Once an object having a grade of at least τ is seen, then it is safe to halt, due to the monotonicity of aggregation function t.

The stopping rule for the threshold algorithm always occurs at least as early as the stopping rule for Fagin's algorithm (that is, with no more sorted accesses than Fagin's algorithm). In Fagin's algorithm, if R is an object that has appeared under sorted access in every list, then by monotonicity, the grade of R is at least equal to the threshold value. Thus, when there are at least k objects, each of which has appeared under sorted access in every list (the stopping rule for FA), there are at least k objects whose grade is at least equal to the threshold value (the stopping rule for FA). This implies that for every database, the sorted access cost for TA is at most that of FA. This does not imply that the middleware cost for TA is always at most that of FA, since TA may do more random accesses than FA. However, since the middleware cost of TA is at most the sorted access cost times a constant (independent of the database size), it does follow that the middleware cost of TA is at most a constant times that of FA.

The consideration of cost leads naturally to an discussion of whether a particular algorithm is optimal. Let A be a class of algorithms, and let D be a class of legal inputs to the algorithms. Define cost(A,D) as the middleware cost incurred by running algorithm A over database D, where AεA and DεD. An algorithm B is instance optimal over A and D if BεA and if for every AεA and every DεD cost(B,D)=O(cost(A,D)), in other words cost(B,D)≦c*cost(A,D)+c′ for every choice of AεA and DεD. The term c is referred to as the optimality ratio.

The term “optimal” reflects that B is essentially the best algorithm in A. The term “instance optimal” refers to optimality in every instance, as opposed to just the worst case or the average case. There are many algorithms that are optimal in a worst-case sense, but are not instance optimal. An example is binary search: in the worst case, binary search is guaranteed to require no more than log N probes, for N data items. However, for each instance, a positive answer can be obtained in one probe, and a negative answer in two probes. The cost of an algorithm that produces the top k answers over a given database can be viewed as the cost of the shortest proof for that database that those are really the top k answers. For some monotone aggregation functions, Fagin's algorithm is optimal with high probability in the worst case. However, the access pattern of Fagin's algorithm is oblivious to the choice of aggregation function, so for each fixed database the middleware cost of Fagin's algorithm is exactly the same no matter what the aggregation function is. Thus, for some monotone aggregation functions, Fagin's algorithm is not optimal in any sense. The threshold algorithm is instance optimal for all monotone aggregation functions when A excludes algorithms that make very lucky guesses (a very weak assumption).

So far, the discussion has focused on methods of rigorously finding the top k objects in a collection or database that best match a set of specified target criteria, and the associated computational cost. However, there are times when the user may be satisfied with an approximate top k list, instead of an exact top k list that incurs a heavier computational penalty. A computationally efficient method of finding an approximate top k list, and an estimate of how close that approximate list is to the exact list, is needed. Similarly, a method of finding a top k list that factors in the relative computational costs of sorted access and random access is also needed.

### SUMMARY OF THE INVENTION

It is accordingly an object of this invention to provide a computationally efficient method of finding a list of k objects best matching specified target attribute criteria, and associated grades, and, if the list is approximate, an estimate of how close the list is to the exact top k list.

It is a related object that the user may specify a parameter describing an acceptable level of approximation, so the method will halt when an acceptable level of approximation is achieved and output its results.

It is a related object that the degree of approximation is displayed during execution, enabling a user to monitor marginal progress and estimate if further computation is likely to be productive.

It is a related object that execution of the method may be interrupted at any time in response to user commands, and approximate results and a measure of approximation produced, regardless of whether any parameter describing an acceptable level of approximation was initially specified by the user.

It is another object of this invention to provide a method of finding a list of k objects best matching specified target attribute criteria that combines individual attribute grades where grades may not be available separately, by combining sorted and random accesses, using random accesses only where there is a high potential payoff. Random accesses may be performed for all the missing fields of only a particular object, versus every object seen in sorted access.

It is a related object of that this invention provides instance optimal algorithms for solving the aggregation problem when a disparity exists between sequential and random access costs.

The foregoing objects are believed to be satisfied by the embodiments of the present invention as described below.

### DETAILED DESCRIPTION OF THE INVENTION

Approximation and Interruption

The preferred embodiment of the present invention provides computationally efficient method of finding an approximate top k list, and an estimate of how close that approximate list is to the exact list. The preferred embodiment modifies the threshold algorithm described above, turning it into an approximation algorithm termed “threshold algorithm-theta” or TA-θ. The approximation algorithm can be used in situations where one cares only about finding the approximate-top-k-answer set, and their grades, without incurring the computational penalty of a more rigorous algorithm.

First, define a parameter θ describing the degree of acceptable approximation to the true solution, where θ>1. Next, define a θ-approximation to the top k answers for the aggregation function t over database D to be a collection of k objects (and their grades) such that for each y among these k objects and each z not among these k objects, θt(y)>=t(z). (Note that the same definition with θ=1 gives the actual top k answers.)

The TA-θ can be implemented by changing the stopping rule in step 2 of the threshold algorithm described above to essentially say “As soon as at least k objects have been seen whose grade is at least equal to τ/θ, then halt”. During iteration, the method monitors β, the grade of the k^{th} (bottom) object in the current top k list. The current threshold value is τ, and the degree of approximation at any moment is therefore τ/β.

The TA-θ algorithm can be further altered to become an interactive process, where at any time the current top k list, and grades, can be shown to the user. The precise degree of approximation, τ/β (which was approaching θ during execution) is also displayed to the user. The user can decide at any time whether to stop the execution of the algorithm prior to its determination of the top k list to the degree of approximation θ initially specified. For example, if there hasn't been a significant decrease in the degree of approximation after some computation has been completed, the user could decide to interrupt the process and simply accept the current results. In a further modification of the preferred embodiment, the initial specification of θ is not even required; θ simply defaults to 1 so the algorithm proceeds to determine the true top k list until it succeeds or is interrupted by a user who monitors its progress as described above.

If the aggregation function t is monotone, and A is the class of all algorithms that find a θ-approximation to the top k answers for t for every database and that do not make wild guesses, then TA-θ is instance optimal over A and D.

If D is the class of all databases that satisfy the uniqueness property, and A is the class of all algorithms that find a θ-approximation to the top answer for min for every database in D, there is no deterministic algorithm (or even probabilistic algorithm that never makes a mistake) that is instance optimal over A and D.

Managing Access Costs

As described above, there may be instances where random accesses are impossible. An algorithm termed NRA (“No Random Accesses”) is now described; it is a modification of the threshold algorithm that makes no random accesses. NRA is instance optimal over all algorithms that do not make random accesses, and over all databases. The optimality ratio of NRA is the best possible.

The output requirement is modified for NRA so that only the top k objects, without their associated grades, are required. The reason is that, since random access is impossible, it may be much cheaper in terms of sorted accesses to find the top k answers without their grades. Sometimes enough partial information can be obtained about grades to know that an object is in the top k objects without knowing its exact grade.

Further, only the top k objects are needed, but no information about the sorted order (sorted by grade) is being required. The sorted order can be easily determined by finding the top object, the top 2 objects, etc. The cost of finding the top k objects in sorted order is at most k maxᵢ Ci, where Ci is the cost of finding the top i objects. In practice, it is usually good enough to know the top k objects in sorted order, without knowing the grades. In fact, the major web search engines no longer output grades, possibly to prevent reverse engineering of their specific mechanisms.

At each point in the execution of the algorithm where a number of sorted and random accesses have taken place, for each object R there is a subset S(R)={i₁, i₂, . . . ,iₗ} [symbol] {1, . . . ,m} of the fields of R where the algorithm has determined the values xᵢ₁, xᵢ₂, . . . ,iᵢₗ of these fields. Given this information, functions are defined that are lower and upper bounds on the value t(R) can obtain. The algorithm proceeds until there are no more candidates whose current upper bound is better than the current k^{th} largest lower bound.

Given an object R and subset S(R)={i₁, i₂, . . . ,iₗ} [symbol] {1, . . . ,m} of known fields of R, with values xᵢ₁, xᵢ₂, . . . ,xᵢₗ, of these known fields, define W_{S}(R) (or W(R) if the subset S=S(R) is clear) as the minimum (or worst) value the aggregation function t can attain for object R. When t is monotone, this minimum value is obtained by substituting for each missing field iε{1, . . . ,m}\S the value 0, and applying t to the result. For example, if S={1, . . . ,l}, then W_{S}(R)=t(x₁,x₂, . . . ,xₗ,0, . . . ,0). If S is the set of known fields of object R, then t(R)≧W_{S}(R). In other words, W(R) represents a lower bound on t(R). Is it the best possible value? Yes, unless additional information is available, such as that the value 0 does not appear in the lists. In general, as execution progresses and more fields of an object R are learned, its W value becomes larger (or at least not smaller). For some aggregation functions t the value W(R) yields no knowledge until S includes all fields: for instance, if t is min, then W(R) is 0 until all values are discovered. For other functions it is more meaningful. For instance, when t is the median of three fields, then as soon as two of them are known W(R) is at least the smaller of the two.

The best value an object can attain depends on other available information. Only the bottom values in each field, defined as in TA, are used: xᵢ is the last (smallest) value obtained via sorted access in list Lᵢ. Given an object R and subset S(R)={i₁, i₂, . . . ,iₗ} [symbol] {1, . . . ,m} of known fields of R, with values xᵢ₁, xᵢ₂, . . . ,xᵢₗ of these known fields, define B_{S}(R) (or B(R) if the subset S=S(R) is clear) as the maximum (or best) value the aggregation function t can attain for object R. When t is monotone, this minimum value is obtained by substituting for each missing field iε{1, . . . ,m}\S the value xᵢ, and applying t to the result. For example, if S={1, . . . ,l}, then B_{S}(R)=t(x₁,x₂, . . . ,xₗ,xₗ₊₁, . . . ,xₘ). If S is the set of known fields of object R, then t(r)≦B_{S}(R). In other words, B(R) represents an upper bound on t(R) given the information available so far. Is it the best upper bound? If the lists may each contain equal values (which is generally assumed), then given the available information it is possible that t(R)=B_{S}(R). If the uniqueness property holds (equalities are not allowed in a list) then for continuous aggregation functions t it is the case that B(R) is the best upper bound on the value t can have on R. In general, as execution progresses and more fields of an object R are learned and the bottom values xᵢ decrease, B(R) can only decrease (or remain the same).

An important special case is an object R that has not been encountered at all. In this case, B(R)=t(x₁,x₂, . . . ,xₘ). Note that this is the same as the threshold value in TA.

The NRA algorithm works as follows:

1. Do sorted access in parallel to each of the m sorted lists Lᵢ. At each depth d (when d objects have been accessed under sorted access in each list):

Maintain the bottom values x₁^{(d)}, x₂^{(d)}, . . . ,xₘ^{(d)} encountered in the lists.

For every object R with discovered fields S=S^{(d)}(R) [symbol] {1, . . . ,m}, compute the values W^{(d)}(R)=W_{S}(R) and B^{(d)}(R)=B_{S}(R). (For objects R that have not been seen, these values are virtually computed as W^{(d)}(R)=t(0, . . . ,0), and B^{(d)}(R)=t(x₁, x₂, . . . ,xₘ), which is the threshold value.)

Let Tₖ^{(d)}, the current top k list, contain the k objects with the largest W^{(d)} values seen so far (and their grades); if two objects have the same W^{(d)} value, then ties are broken using the B^{(d)} values, such that the object with the highest B^{(d)} value wins (and arbitrarily among objects that tie for the highest B^{(d)} value). Let Mₖ^{(d)} be the k^{th} largest W^{(d)} value in Tₖ^{(d)}.

2. Call an object R viable if B^{(d)}(R)>Mₖ^{(d)}. Halt when (a) at least k distinct objects have been seen (so that in particular Tₖ^{(d)} contains k objects) and (b) there are no viable objects left outside Tₖ^{(d)}, that is, when B^{(d)}(R)≦Mₖ^{(d)} for all R∉Tₖ^{(d)}. Return the objects in Tₖ^{(d)}.

NRA correctly finds the top k objects if aggregation function t is monotone. NRA is instance optimal over all algorithms that do not use random access. Unfortunately, the execution of NRA may require a lot of bookkeeping at each step, since when NRA does sorted access at depth t (for 1≦t≦d), the value of B^{(t)}(R) must be updated for every object R seen so far. This may take up to dm updates for each depth t, which yields a total of Ω(d²) updates by depth d. Furthermore, unlike the threshold algorithm, it no longer suffices to have bounded buffers.

What about situations where random access is not impossible, but is simply expensive? Wimmers et al. [E. L. Wimmers, L. M. Haas, M. Tork Roth, and C. Braendli. Using Fagin's algorithm for merging ranked results in multimedia middleware. In Fourth IFCIS International Conference on Cooperative Information Systems, pages 267-278, IEEE Computer Society Press, September 1999, hereby incorporated by reference] discuss a number of systems issues that can cause random access to be expensive. Although the threshold algorithm is instance optimal, the optimality ratio depends on the ratio c_{R}/c_{S}, the cost of a single random access to the cost of a single sorted access.

The second embodiment of the present invention is another method for determining which objects in a collection best match specified target attribute criteria while considering the relative cost of random accesses. Termed “CA” for “combined algorithm”, this scheme can be viewed as a novel and non-obvious combination of TA and NRA that intuitively minimizes random accesses, using them only if there is a high potential payoff.

The definition of the combined algorithm depends on h=c_{R}/c_{S}. Typically c_{R}≧c_{S}, so h≧1. The motivation is to obtain an algorithm that is not only instance optimal, but whose optimality ratio is independent of c_{R}/c_{S}. As with NRA, the required output is only the top k objects, without their grades. Obtaining the grades requires only a constant number of additional random accesses, and so has no effect on instance optimality.

The intuitive idea of the combined algorithm is to run NRA, but every h steps to run a random access phase and update the information (the upper and lower bounds B and W described above) accordingly.

The combined algorithm works as follows:

1. Do sorted access in parallel to each of the m sorted lists Lᵢ. At each depth d (when d objects have been accessed under sorted access in each list):

Maintain the bottom values x₁^{(d)}, x₂^{(d)}, . . . ,xₘ^{(d)} encountered in the lists.

For every object R with discovered fields S=S^{(d)}(R) [symbol] {1, . . . ,m}, compute the values W^{(d)}(R)=W_{S}(R) and B^{(d)}(R)=B_{S}(R). (For objects R that have not been seen, these values are virtually computed as W^{(d)}(R)=t(0, . . . ,0), and B^{(d)}(R)=t(x₁, x₂, . . . ,xₘ), which is the threshold value.)

Let Tₖ^{(d)}, the current top k list, contain the k objects with the largest W^{(d)} values seen so far (and their grades); if two objects have the same W^{(d)} value, then ties are broken using the B^{(d)} values, such that the object with the highest B^{(d)} value wins (and arbitrarily among objects that tie for the highest B^{(d)} value). Let Mₖ^{(d)} be the k^{th} largest W^{(d)} value in Tₖ^{(d)}.

2. Call an object R viable if B^{(d)}(R)>Mₖ^{(d)}. Every h steps (that is, every time the depth of sorted access increases by h), do the following: pick the viable object that has been seen for which not all fields are known and whose B(d) value is as big as possible (ties are broken arbitrarily). Perform random accesses for all of its (at most m−1) missing fields. If there is no such object, then do not do a random access on this step.

3. Halt when (a) at least k distinct objects have been seen (so that in particular Tₖ^{(d)} contains k objects) and (b) there are no viable objects left outside Tₖ^{(d)}, that is, when B^{(d)}(R)≦Mₖ^{(d)} for all R∉Tₖ^{(d)}. Return the objects in Tₖ^{(d)}.

Note that if h is very large (say larger than the number of objects in the database), then the combined algorithm is the same as NRA, since no random access is performed. If h=1, then CA is similar to TA, but different in intriguing ways. For each step of doing sorted access in parallel, CA performs random accesses for all of the missing fields of some object. Instead of performing random accesses for all the missing fields of some object, TA performs random accesses for all of the missing fields of every object seen in sorted access. For moderate values of h it is not the case that CA is equivalent to the intermittent algorithm that executes h steps of NRA and then one step of TA. There are instances where the intermittent algorithm performs much worse than CA. The difference between the algorithms is that CA picks “wisely” on which objects to perform the random access, namely, according to their B^{(d)} values. The combined algorithm correctly finds the top k objects if the aggregation function t is monotone.

One would hope that CA would be instance optimal (with optimality ratio independent of c_{R}/c_{S}) in those scenarios where TA is instance optimal. Not only does this hope fail, but there does not exist any deterministic algorithm, or even a probabilistic algorithm that does not make a mistake, with optimality ratio independent of c_{R}/c_{S}.in those scenarios.

A general purpose computer is programmed according to the inventive steps herein. The invention can also be embodied as an article of manufacture—a machine component—that is used by a digital processing apparatus to execute the present logic. This invention is realized in a critical machine component that causes a digital processing apparatus to perform the inventive method steps herein. The invention may be embodied by a computer program that is executed by a processor within a computer as a series of computer-executable instructions. These instructions may reside, for example, in RAM of a computer or on a hard drive or optical drive of the computer, or the instructions may be stored on a DASD array, magnetic tape, electronic read-only memory, or other appropriate data storage device.

While the particular OPTIMAL APPROXIMATE APPROACH TO INTEGRATING INFORMATION as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for”.

We claim:

1. A computer-implemented method for determining which objects in a collection best match specified target attribute criteria, the method comprising the steps of:
assigning individual attribute grades describing a specific attribute criterion to attributes of said objects;
sorting said objects into a list according to each individual attribute grade in decreasing order;
combining said individual attribute grades into an overall grade describing said target attribute criteria match for each object using a monotone aggregation function; and
selecting k objects having said highest overall grades, where k is a specified number.

2. The method of claim 1 including the further step of:
stopping said combining step when at least k objects have been seen whose grade is at least equal to a threshold value divided by a user-specified parameter describing an acceptable level of approximation to said top k objects' match to said criteria.

3. The method of claim 1 including the further step of:
displaying a numerical value describing a level of approximation of the current top k list of objects to the true top k list of objects, enabling a user to monitor marginal progress over time.

4. The method of claim 1 including the further step of:
interrupting said steps in response to user commands, without requiring user specification of a parameter describing an acceptable level of approximation to said top k objects' match to said criteria.

5. The method of claim 1 including the further steps, performed after said sorting step:
selecting a particular object that has been seen but for which not all individual attribute grades are known, and for which the weighting of individual attribute grades is largest; and
based on the increase in depth of sorted access, selectively and periodically performing a random access for a predetermined number of individual attribute grades for said particular object.

6. The method of claim 5 including the further steps of:
defining and iteratively updating functions describing upper and lower bounds of aggregation function values; and
halting execution of said steps when no more candidate objects exist with a current upper bound that is better than the current k^{th} largest lower bound.

7. A general purpose computer system programmed with instructions to determine which objects in a collection best match specified target attribute criteria, the instructions comprising:
assigning individual attribute grades describing a specific attribute criterion to attributes of said objects;
sorting said objects into a list according to each individual attribute grade in decreasing order;
combining said individual attribute grades into an overall grade describing said target attribute criteria match for each object using a monotone aggregation function; and
selecting k objects having said highest overall grades, where k is a specified number.

8. The system of claim 7 including the further instruction of:
stopping said combining instruction when at least k objects have been seen whose grade is at least equal to a threshold value divided by a user-specified parameter describing an acceptable level of approximation to said top k objects' match to said criteria.

9. The system of claim 7 including the further instruction of:
displaying a numerical value describing a level of approximation of the current top k list of objects to the true top k list of objects, enabling a user to monitor marginal progress over time.

10. The system of claim 7 including the further instruction of:
interrupting said instructions in response to user commands, without requiring user specification of a parameter describing an acceptable level of approximation to said top k objects' match to said criteria.

11. The system of claim 7 including the further instructions of:
selecting a particular object that has been seen but for which not all individual attribute grades are known, and for which the weighting of individual attribute grades is largest; and
based on the increase in depth of sorted access, selectively and periodically performing a random access for a predetermined number of individual attribute grades for said particular object.

12. The system of claim 11 including the further instructions of:
defining and iteratively updating functions describing upper and lower bounds of aggregation function values; and
halting execution of said instructions when no more candidate objects exist with a current upper bound that is better than the current k^{th} largest lower bound.

13. A system for determining which objects in a collection best match specified target attribute criteria, comprising:
means for assigning individual attribute grades describing a specific attribute criterion to attributes of said objects;
means for sorting said objects into a list according to each individual attribute grade in decreasing order;
means for combining said individual attribute grades into an overall grade describing said target attribute criteria match for each object using a monotone aggregation function; and
means for selecting k objects having said highest overall grades, where k is a specified number.

14. A computer program product comprising a machine-readable medium having computer-executable program instructions thereon for determining which objects in a collection best match specified target attribute criteria, including:
a first code means for assigning individual attribute grades describing a specific attribute criterion to attributes of said objects;
a second code means for sorting said objects into a list according to each individual attribute grade in decreasing order;
a third code means for combining said individual attribute grades into an overall grade describing said target attribute criteria match for each object using a monotone aggregation function; and
a fourth code means for selecting k objects having said highest overall grades, where k is a specified number.
